(19) United States
(12) Patent Application Publication
(10) Pub. No.: US 2015/0240034 A1
(43) Pub. Date: Aug. 27, 2015

(54) METHOD FOR FORMING NANOSCALE MICROSTRUCTURE

(71) Applicant: National University of Kaohsiung, KAOHSIUNG (TW)

(72) Inventors: Yi-Chang Chung, KAOHSIUNG (TW); Wan-Yi Chang, KAOHSIUNG (TW)

(73) Assignee: National University of Kaohsiung, KAOHSIUNG (TW)

(21) Appl. No.: 14/275,991

(22) Filed: May 13, 2014

(30) Foreign Application Priority Data
Feb. 24, 2014 (TW) 103105983

(51) Int. Cl. C08G 77/04

(52) U.S. Cl. CPC C08G 77/04

(57) ABSTRACT

A method for forming nanoscale microstructures by solvent etching comprises steps of preparing nanospheres and placing the nanospheres onto a surface of a liquid and allowing the nanospheres to be regularly arranged to form a template. The template is transferred to the photocurable adhesive of the substrate to form a photocured adhesive layer. After photocuring the photocurable adhesive to form a photocured adhesive layer, the substrate is removed and the template and the photocured adhesive layer are placed into a solvent with insignificant polarity to perform etching by dissolving the template with the solvent to form the nanoscale microstructure on the photocured adhesive layer. The method does not require large-scale machines, expensive equipments, and long processing time of molecular self-assembly. In addition to the above advantages, this method is not limited by size of substrates.

### BACKGROUND OF THE INVENTION

1. Field of the Invention

The present invention relates to a method for forming nanoscale microstructures by solvent etching.

2. Description of the Related Art

A trend of technology is directed to miniaturization, which includes the miniaturizations of mobile phone chips, TV display panels, and daily necessities that require countless microscale or nanoscale structures formed on materials for functionality enhancement. It is, however, significantly difficult to manufacture such tiny structures. Conventional methods for constructing nanostructures include photo lithography and plasma etching. These methods require complicated and expensive equipments and practicing of which is not affordable for small businesses or individuals.

Molecule stacking is another conventional means for building nanoscale microstructures, which employs moulds to allow gradual self-assembly of molecules that leads to the construction of nanoscale microstructures corresponding to the shape of the moulds on a substrate. Yet molecule stacking is known to be time-consuming and demands a fine-tuned environment to make possible stable and robust constructions by molecular self-assembly.

A conventional method aiming to develop loosely aligned nanocavities employs processing of polystyrene (PS) particles by complicated, expensive and time-consuming plasma etching. This method minimizes the diameters of the PS particles and produces loosely aligned nanoscale patterns by means of replica molding.

Therefore, it is apparent that a rapid and easy-to-perform method capable of producing nanoscale microstructure is urgently needed to resolve the shortcomings of conventional techniques which require high cost, complex steps and long processing time.

### SUMMARY OF THE INVENTION

An objective of the present invention is to provide a method for forming nanoscale microstructures by solvent etching in order to solve the above shortcomings of conventional methods. The present method does not require large-scale machines and expensive equipments and can easily produce nanoscale microstructures.

To achieve the foregoing objective, the method for manufacturing nano/micro structures by solvent treatment comprises the following steps:

(a) Preparing nanospheres;

(b) Injecting the nanospheres onto a surface of a liquid and allowing the nanospheres to be regularly arranged to form a first array to construct a template having a nanospherical structure;

(c) Lifting the template out from the surface of the liquid with an oblique plate, allowing a liquid residue to flow off from the oblique plate on which the template remains;

(d) Preparing a substrate coated with a photocurable adhesive;

(e) Transferring the template to the photocurable adhesive of the substrate, subsequently photocuring the photocurable adhesive to form a photocured adhesive layer, and removing the substrate from the photocured adhesive layer on which the template is retained; and

(f) Placing the template and the photocured adhesive layer into a solvent with insignificant polarity to perform etching by dissolving the template with the solvent to form the nanoscale microstructure on the photocured adhesive layer.

Preferably, the nanospheres are polystyrene (PS) nanospheres having core-shell structures. An average diameter of the PS nanospheres ranges from 200 nm to 800 nm.

Preferably, the substrate is a translucent material. More preferably, the material is Polyethylene terephthalate (PET).

Preferably, the solvent with insignificant polarity is Toluene or Dichloromethane. The solvent provides dispersing force or Van der Waals force to perform etching to the template of the photocured adhesive layer for dissolving the template in the solvent.

Preferably, the step (b) further comprises adding a surfactant into the liquid and changing the surface tension of the liquid. This process will develop closely aligned nanospheres onto the surface of the liquid.

More preferably, the surfactant is Sodium Dodecyl Sulfate (SDS).

Preferably, the step (b) further comprises allowing the nanospheres to form a second array on the first array such that the first array and the second array together construct a template having a multi-layer microspherical structure. The first array and the second array are attracted together by polarity or hydrogen bond force from the nanospheres' shell layer.

Preferably, step (f) further comprises: covering a polymeric material on the photocured adhesive layer having the nanoscale microstructure, and allowing a contrast nanoscale microstructure corresponding to the nanoscale microstructure to be imprinted on the polymeric material.

More preferably, the polymeric material is Polydimethylsiloxane (PDMS).

In summary, the present invention is to provide a method for forming nanoscale microstructures by solvent etching. The method adopts an easy-to-perform step of injecting nanospheres onto a surface of a liquid and thus allows the nanospheres to be regularly arranged to form a template. The template is then transferred to the photocurable adhesive of the substrate to form a photocured adhesive layer. Finally, the substrate is removed while the template and the photocured adhesive layer are placed into a solvent with insignificant polarity to perform etching by dissolving the template with the solvent to form the nanoscale microstructure on the photocured adhesive layer.

### BRIEF DESCRIPTION OF THE DRAWINGS

FIG. 1 shows operational views of a method for forming nanoscale microstructures in accordance with the present invention;

FIG. 2 is a block diagram of the method for forming nanoscale microstructures; and

FIG. 3 is a SEM image of nanoscale microstructures in accordance with the present invention.

### DETAILED DESCRIPTION OF THE INVENTION

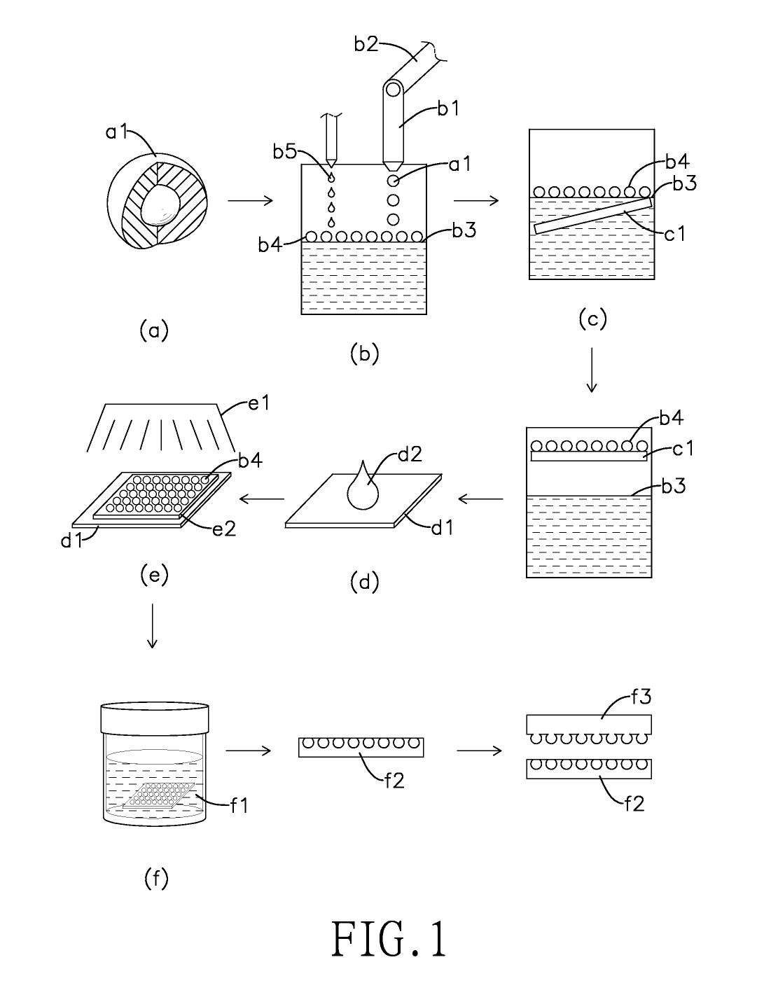

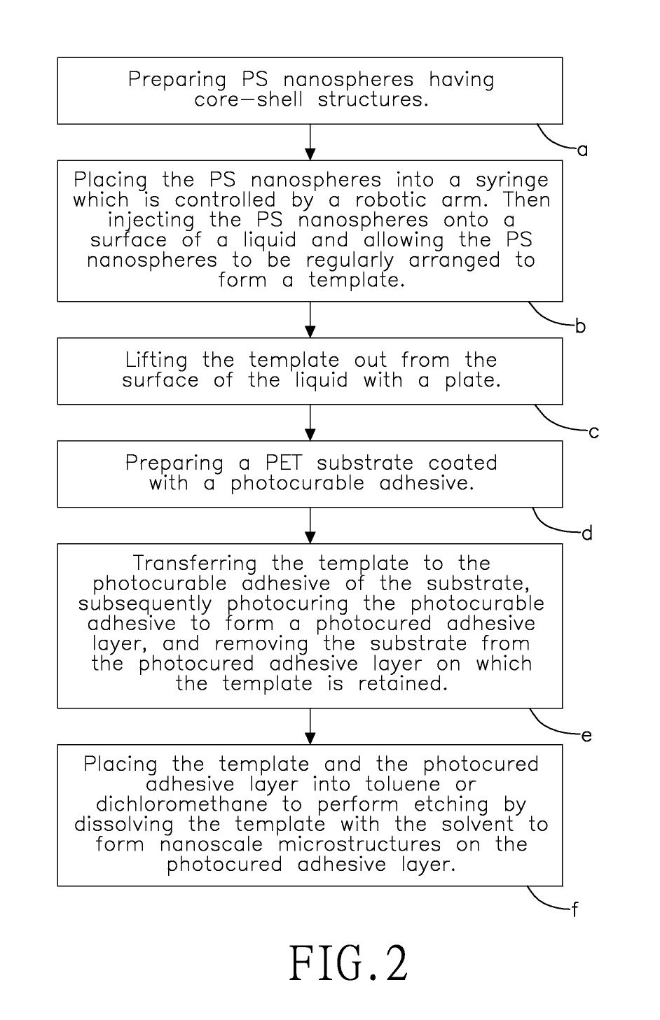

With reference to FIGS. 1 and FIG. 2, the method for manufacturing nano/micro structures by solvent treatment comprises steps of:

(a) Preparing polystyrene (PS) nanospheres a1 having core-shell structures;

(b) Placing the PS nanospheres a1 into a syringe b1 controlled by a robotic arm b2. Then injecting the PS nanospheres a1 onto a surface of a liquid b3 and allowing the PS nanospheres a1 to be regularly arranged to form a first array to construct a template b4 having a nanospherical structure;

(c) Lifting the template b4 out from the surface of the liquid b3 with an oblique plate c1, allowing a liquid residue to flow off from the oblique plate c1 on which the template b4 remains;

(d) Preparing a Polyethylene terephthalate (PET) substrate d1 coated with a photocurable adhesive d2. The coating method is spin coating. This step can be processed in prior to or simultaneously with any one of steps (a) to (c);

(e) Transferring the template b4 to the photocurable adhesive d2 of the PET substrate d1, subsequently photocuring the photocurable adhesive d2 to form a photocured adhesive layer e2, and removing the PET substrate d1 from the photocured adhesive layer e2 on which the template b4 is retained;

(f) Placing the template b4 and the photocured adhesive layer e2 into a solvent f1 with insignificant polarity to perform etching by dissolving the template b4 with the solvent f1 to form nanoscale cavities f2 on the photocured adhesive layer e2. In addition, the step (f) further comprises: covering a Polydimethylsiloxane (PDMS) material on the photocured adhesive layer e2 having the nanoscale cavities f2, and allowing a contrast nanoscale microstructure f3 corresponding to the nanoscale cavities f2 to be imprinted on the PDMS material.

In the instant embodiment, the average diameter of the PS nanospheres a1 ranges from 200 nm to 800 nm.

In the instant embodiment, the solvent f1 with insignificant polarity is Toluene or Dichloromethane. The solvent f1 provides dispersing force or Van der Waals force to perform etching on the template b4 of the photocured adhesive layer e2. The template b4 is dissolved in the solvent f1. In other embodiments, the solvent with insignificant polarity may be a non-polar solvent or a low-polar solvent.

In the instant embodiment, the step (b) further comprises adding a surfactant b5 into the liquid. The surfactant b5 used in the instant embodiment is Sodium Dodecyl Sulfate (SDS). The surfactant b5, which may be a surfactant other than the aforementioned SDS, changes the surface tension of the liquid b3 and thereby aligns the PS nanospheres a1 closely onto the surface of the liquid b3.

In a preferred embodiment, the step (b) further comprises allowing the PS nanospheres a1 to form a second array on the first array such that the first array and the second array together construct a template having a multi-layer microspherical structure. The first array and the second array are attracted together by polarity or hydrogen bond force from the PS nanospheres' shell layer.

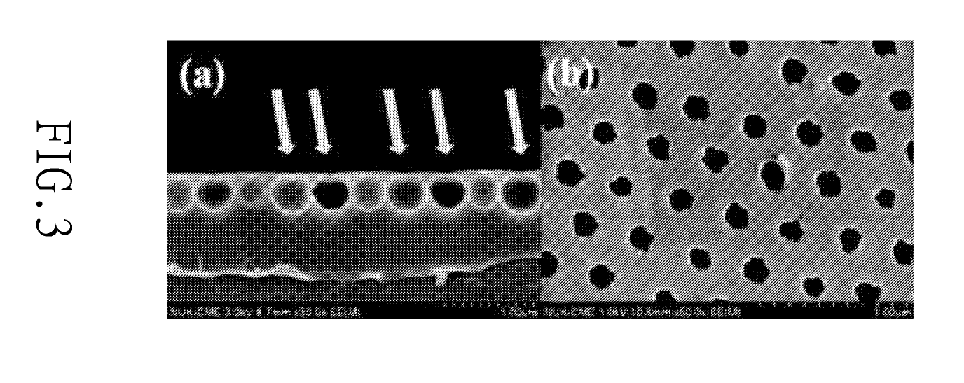

With further reference to FIG. 3, Panel (a) demonstrates a cross-sectional view and Panel (b) demonstrates a top view (b) of SEM photographs of the nanoscale cavities f2, wherein the nanoscale cavities f2 are aligned regularly.

In summary, the present invention provides a method for forming nanoscale microstructures by solvent etching PS nanospheres a1 are placed onto a surface of a liquid b3. The PS nanospheres a1 are allowed to be regularly arranged to form a template b4. The template b4 is afterwards transferred to a photocurable adhesive d2 of the substrate d1. After photocuring the photocurable adhesive d2 to form a photocured adhesive layer e2, the substrate d1 is removed and the template b4 and the photocured adhesive layer e2 are placed into a solvent f1 with insignificant polarity to perform etching by dissolving the template b4 with the solvent f1 in order to form the nanoscale microstructures on the photocured adhesive layer e2. This method helps resolve the shortcomings of conventional techniques that require high cost, complex steps and long processing time.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for forming a nanoscale microstructure, comprising steps of:
(a) preparing nanospheres;
(b) injecting the nanospheres onto a surface of a liquid and allowing the nanospheres to be regularly arranged to form a first array to construct a template having a nanospherical structure;
(c) lifting the template out from the surface of the liquid with an oblique plate, allowing a liquid residue to flow off from the oblique plate on which the template remains;
(d) Preparing a substrate coated with a photocurable adhesive;
(e) Transferring the template to the photocurable adhesive of the substrate, subsequently photocuring the photocurable adhesive to form a photocured adhesive layer, and removing the substrate from the photocured adhesive layer on which the template is retained; and
(f) Placing the template and the photocured adhesive layer into a solvent with insignificant polarity to perform etching by dissolving the template with the solvent to form the nanoscale microstructure on the photocured adhesive layer.

2. The method as claimed in claim 1, wherein the solvent with insignificant polarity is Toluene or Dichloromethane.

3. The method as claimed in claim 1, wherein the step (f) further comprises: covering a polymeric material on the photocured adhesive layer having the nanoscale microstructure, and allowing a contrast nanoscale microstructure corresponding to the nanoscale microstructure to be imprinted on the polymeric material.

4. The method as claimed in claim 2, wherein the step (f) further comprises: covering a polymeric material on the photocured adhesive layer having the nanoscale microstructure, and allowing a contrast nanoscale microstructure corresponding to the nanoscale microstructure to be imprinted on the polymeric material.

5. The method as claimed in claim 3, wherein the polymeric material is Polydimethylsiloxane.

6. The method as claimed in claim 4, wherein the polymeric material is Polydimethylsiloxane.

7. The method as claimed in claim 1, wherein the step (b) further comprises adding a surfactant into the liquid.

8. The method as claimed in claim 6, wherein the step (b) further comprises adding a surfactant into the liquid.

9. The method as claimed in claim 7, wherein the surfactant is Sodium Dodecyl Sulfate.

10. The method as claimed in claim 8, wherein the surfactant is Sodium Dodecyl Sulfate.

11. The method as claimed in claim 1, wherein the step (b) further comprises allowing the nanospheres to form a second array on the first array such that the first array and the second array together construct a template having a multi-layer microspherical structure.

12. The method as claimed in claim 10, wherein the step (b) further comprises allowing the nanospheres to form a second array on the first array such that the first array and the second array together construct a template having a multi-layer microspherical structure.

13. The method as claimed in claim 1, wherein the nanospheres are polystyrene nanospheres having core-shell structures.

14. The method as claimed in claim 13, wherein an average diameter of the polystyrene nanospheres ranges from 200 nm to 800 nm.

15. The method as claimed in claim 14, wherein the solvent with insignificant polarity is Toluene or Dichloromethane.

16. The method as claimed in claim 15, wherein the step (b) further comprises adding a surfactant into the liquid.

17. The method as claimed in claim 16, wherein the step (f) further comprises: covering a polymeric material on the photocured adhesive layer having the nanoscale microstructure, and allowing a contrast nanoscale microstructure corresponding to the nanoscale microstructure to be imprinted on the polymeric material.

18. The method as claimed in claim 17, wherein the step (b) further comprises allowing the nanospheres to form a second array on the first array such that the first array and the second array together construct a template having a multi-layer microspherical structure.
